(19) United States
(12) Patent Application Publication
(10) Pub. No.: US 2024/0292312 A1
(43) Pub. Date: Aug. 29, 2024

(54) RELAY ASSISTED FULL DUPLEX RELAY FROM NETWORK TO REMOTE UE IN SIDELINK MODE 1

(71) Applicant: QUALCOMM Incorporated, San Diego, CA (US)

(72) Inventors: Yan ZHOU, San Diego, CA (US); Hemant SAGGAR, San Diego, CA (US)

(21) Appl. No.: 18/583,755

(22) Filed: Feb. 21, 2024

Related U.S. Application Data
(60) Provisional application No. 63/487,586, filed on Feb. 28, 2023.

(51) Int. Cl. H04W 40/22; H04L 1/1812; H04L 5/14; H04W 76/20; H04W 88/04

(52) U.S. Cl. CPC H04W 40/22; H04L 1/1812; H04L 5/14; H04W 76/20; H04W 88/04

(57) ABSTRACT

A relay UE may identify feasibility of FD relaying at the relay UE. The FD relaying at the relay UE may include simultaneous downlink reception from a network node and sidelink transmission to a remote UE. The relay UE may transmit, for the network node, an FD relay assistance information message based on the identified feasibility of the FD relaying at the relay UE. The network node may schedule a first downlink transmission from the network node to the relay UE and at least one first sidelink transmission from the relay UE to the remote UE based on the FD relay assistance information message.

### CROSS REFERENCE TO RELATED APPLICATION(S)

This application claims the benefit of and priority to U.S. Provisional Application Ser. No. 63/487,586, entitled “RELAY ASSISTED FULL DUPLEX RELAY FROM NETWORK TO REMOTE UE IN SIDELINK MODE 1” and filed on Feb. 28, 2023, which is expressly incorporated by reference herein in its entirety.

### TECHNICAL FIELD

The present disclosure relates generally to communication systems, and more particularly, to full-duplex (FD) relaying at a relay user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a relay user equipment (UE). The apparatus may identify feasibility of full-duplex (FD) relaying at the relay UE. The FD relaying at the relay UE may include simultaneous downlink reception from a network node and sidelink transmission to a remote UE. The apparatus may transmit, for the network node, an FD relay assistance information message based on the identified feasibility of the FD relaying at the relay UE.

In an aspect of the disclosure, a method, a computer-readable medium, and an apparatus are provided. The apparatus may be network node. The apparatus may receive an FD relay assistance information message from a relay UE. The FD relay assistance information message may include an indication of feasibility of FD relaying at the relay UE. The FD relaying at the relay UE may include simultaneous downlink reception from the network node and sidelink transmission to a remote UE. The apparatus may schedule a first downlink transmission from the network node to the relay UE and at least one first sidelink transmission from the relay UE to the remote UE based on the FD relay assistance information message.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example vehicle-to-everything (V2X) communication.

FIG. 5 is a diagram illustrating an example full-duplex (FD) relaying operation at a UE according to one or more aspects.

FIG. 6 is a diagram illustrating an example FD relay operation at an integrated access backhaul (IAB) node.

FIG. 7 is a diagram illustrating an example FD relaying operation at a UE according to one or more aspects.

FIG. 8 is a diagram illustrating an example FD relaying operation at a UE according to one or more aspects.

FIG. 9 is a diagram illustrating an example FD relaying operation at a UE according to one or more aspects.

FIG. 10 is a diagram illustrating the transmission of an example FD relay assistance information message according to one or more aspects.

FIG. 11 is a diagram illustrating an example application time associated with FD relaying according to one or more aspects.

FIG. 12 is a diagram of a communication flow of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

In some aspects, due to varying environments, the network node (e.g., a base station) may need to track whether full-duplex (FD) relaying is feasible. For example, FD relaying at a relay user equipment (UE) may not be feasible if there is strong self-interference (SI) caused by a reflector near the relay UE. In another example, FD relaying at a relay UE may not be feasible if both the Uu link and the sidelink use the same antenna panel at the relay UE. In one example configuration, the network node may determine (decide) the FD relay feasibility at the relay UE by collecting FD performance-related metrics from the relay UE. However, this approach may have a non-negligible impact on communication overhead and/or latency.

In some example aspects, a relay UE may identify feasibility of FD relaying at the relay UE. The FD relaying at the relay UE may include simultaneous downlink reception from a network node and sidelink transmission to a remote UE. The relay UE may transmit, for the network node, an FD relay assistance information message based on the identified feasibility of the FD relaying at the relay UE. The network node may schedule a first downlink transmission from the network node to the relay UE and at least one first sidelink transmission from the relay UE to the remote UE based on the FD relay assistance information message.

Particular aspects of the subject matter described in this disclosure can be implemented to realize one or more of the following potential advantages. In some examples, the described techniques can be used to enable the network node to track whether FD relaying is feasible at the relay UE and schedule communications accordingly without incurring communication overhead and/or latency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

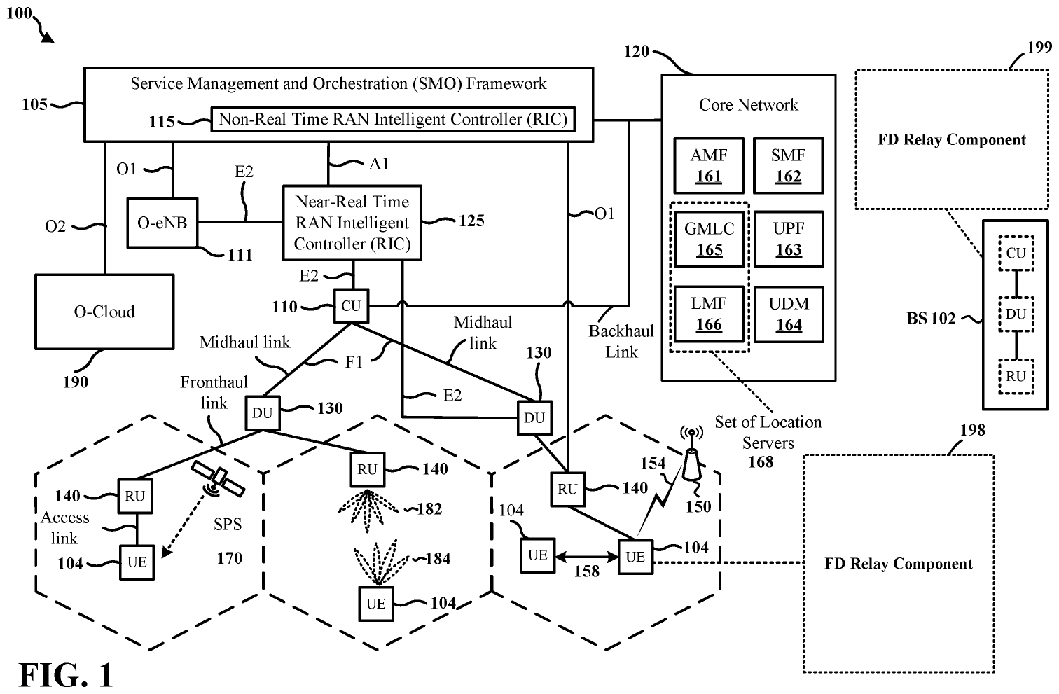

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a relay UE 104 may have an FD relay component 198 that may be configured to identify feasibility of FD relaying at the relay UE. The FD relaying at the relay UE may include simultaneous downlink reception from a network node and sidelink transmission to a remote UE. The FD relay component 198 may be configured to transmit, for the network node, an FD relay assistance information message based on the identified feasibility of the FD relaying at the relay UE. In certain aspects, the base station 102 may have an FD relay component 199 that may be configured to receive an FD relay assistance information message from a relay UE. The FD relay assistance information message may include an indication of feasibility of FD relaying at the relay UE. The FD relaying at the relay UE may include simultaneous downlink reception from the network node and sidelink transmission to a remote UE. The FD relay component 199 may be configured to schedule a first downlink transmission from the network node to the relay UE and at least one first sidelink transmission from the relay UE to the remote UE based on the FD relay assistance information message. In other words, the relay UE may determine the feasibility of FD relaying at the relay UE and may report the FD relaying feasibility to the network node. The network node may schedule communications accordingly based on the received report of the FD relaying feasibility at the relay UE.

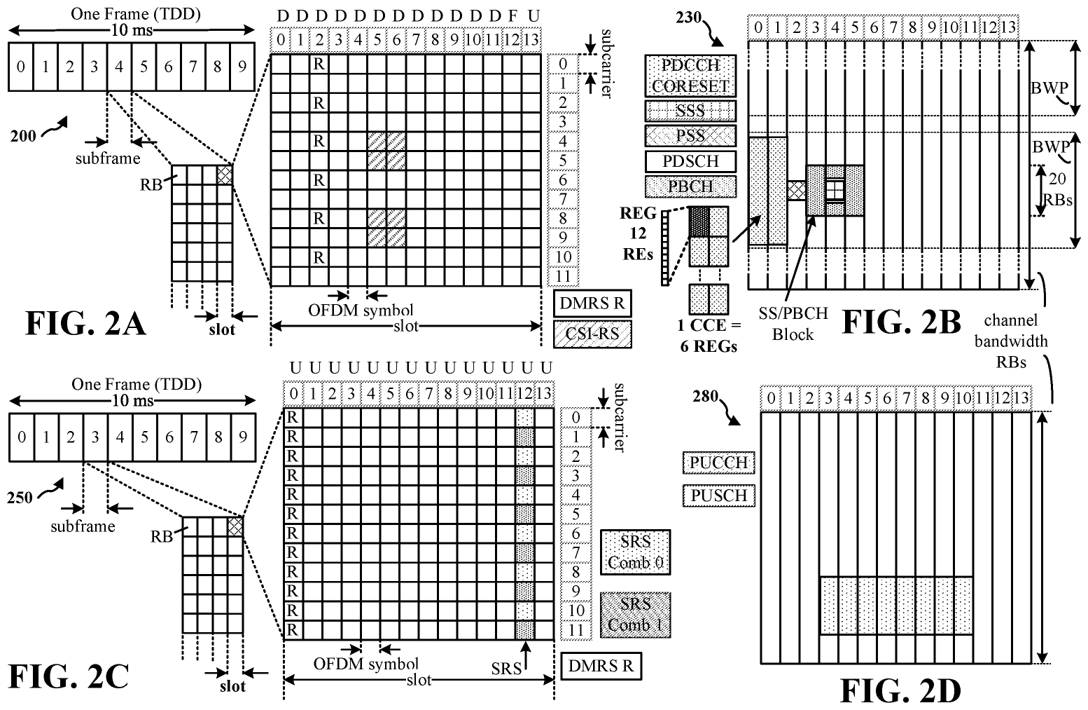

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

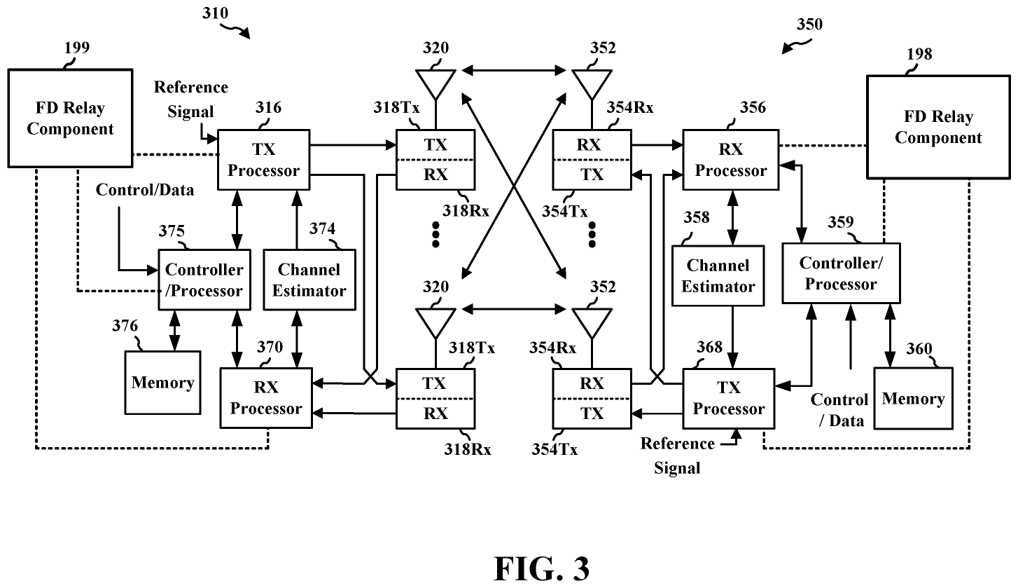

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the FD relay component 198 of FIG. 1.

At least one of the TX processor 316, the RX processor 370, and the controller/processor 375 may be configured to perform aspects in connection with the FD relay component 199 of FIG. 1.

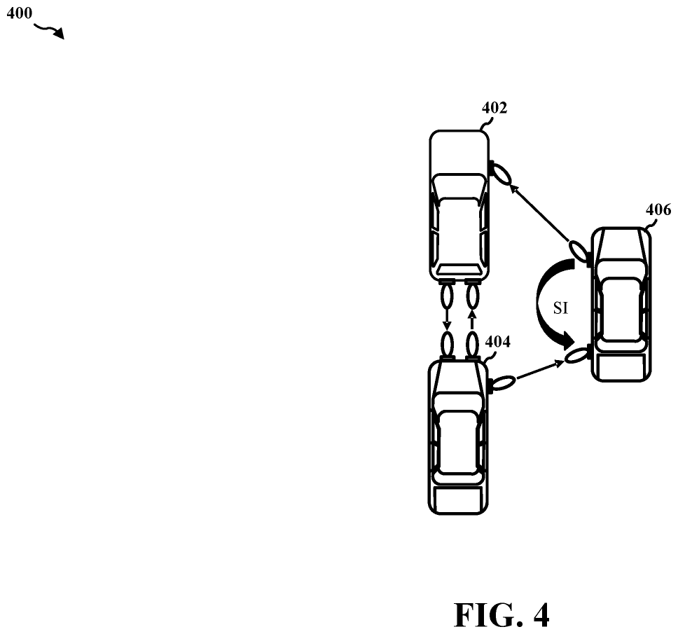

FIG. 4 is a diagram 400 illustrating example vehicle-to-everything (V2X) communication. As shown, through the various antenna arrays equipped at the vehicle UEs 402, 404, 406, the vehicle UEs 402, 404, 406 may communicate with each other based on the V2X communication. Simultaneous transmission and reception at a device may be referred to the FD operation at the device. In general, the FD operation may be associated with SI. For example, a vehicle UE may experience SI if the vehicle UE transmits and receives at the same time. For example, as shown in FIG. 4, as the vehicle UE 406 transmits to the vehicle UE 402 and receives from the vehicle UE 404 at the same time, the vehicle UE 406 may experience SI. In particular, at the vehicle UE 406, the transmission to the vehicle UE 402 may cause interference to the reception from the vehicle UE 404.

The SI at a device may be mitigated by spatial isolation between the Tx antenna panel/array and the Rx antenna panel/array. In the case of the V2X communication, the vehicle (vehicle UE) and/or the road-side unit (RSU) may have more space to achieve sufficient spatial isolation between Tx and Rx panels/arrays. Moreover, in the case of FR2 or FRx, the SI may be further reduced due to the greater beamforming gain achieved with more antenna elements per panel/array. In different configurations, the FD operation may be implemented at an IAB node, a repeater, a network node (e.g., a base station), and/or a UE.

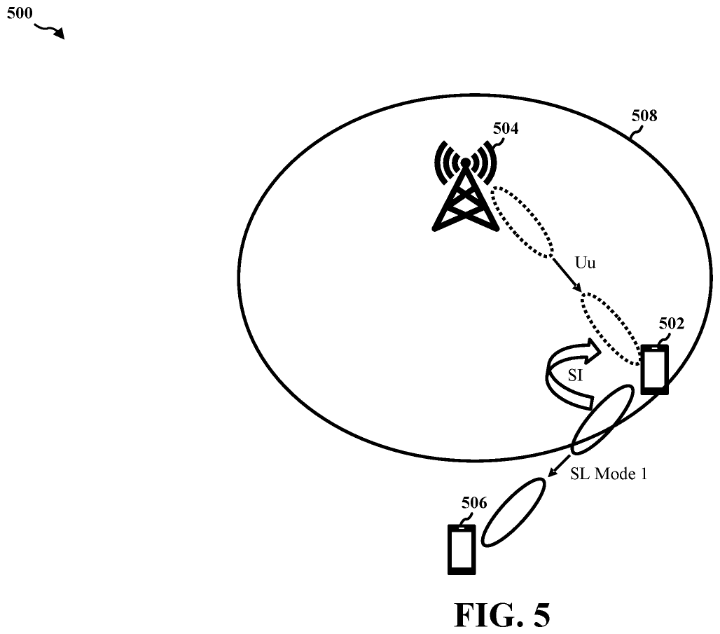

FIG. 5 is a diagram 500 illustrating an example FD relaying operation at a UE according to one or more aspects. As shown, a relay UE 502 may relay (forward) a transmission received from the network node 504 to a remote UE 506 (i.e., the relaying direction may be in the forward direction). The link from the network node 504 to the relay UE 502 may be a Uu link (i.e., the link from the network node 504 to the relay UE 502 may be a downlink). In other words, the relay UE 502 may be inside the coverage area 508 of the network node 504. Further, the link from the relay UE 502 to the remote UE 506 may be a sidelink. In particular, in some configurations, the sidelink between the relay UE 502 and the remote UE 506 may operate in Mode 1. In general, in Mode 1, a network node (e.g., a base station) may allocate resources for the direct sidelink communication between the UEs, whereas in Mode 2, UEs participating in the sidelink communication may select resources based on sensing without intervention from a network node. In different configurations, the remote UE 506 may be either inside or outside of the coverage area 508 of the network node 504. In some configurations, to perform the relay operation, the relay UE 502 may operate in the FD mode, that is, the relay UE 502 may receive a communication from the network node 504 via the Uu link and may transmit a communication to the remote UE 506 via the sidelink at the same time. Hereinafter such an operation at the relay UE 502 may be referred to as a (UE) FD relay (relaying) operation.

In some aspects, due to varying environments, the network node (e.g., a base station) may need to track whether FD relaying is feasible. For example, FD relaying at a relay UE may not be feasible if there is strong SI caused by a reflector near the relay UE. In another example, FD relaying at a relay UE may not be feasible if both the Uu link and the sidelink use the same antenna panel at the relay UE. In one example configuration, the network node may determine (decide) the FD relay feasibility at the relay UE by collecting FD performance-related metrics from the relay UE. However, this approach may have a non-negligible impact on communication overhead and/or latency. In further example configurations, the relay UE may determine (decide) the FD relay feasibility, and may inform the network node about the FD relay feasibility.

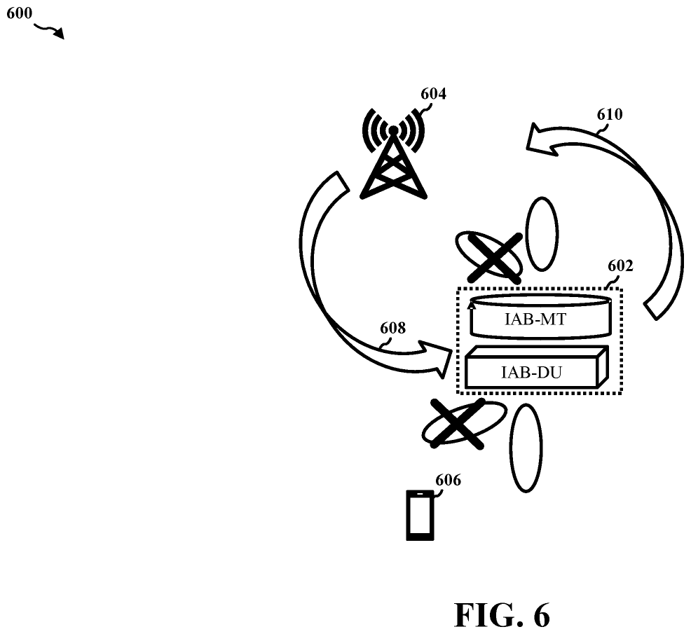

FIG. 6 is a diagram 600 illustrating an example FD relay operation at an IAB node. As shown, the IAB node 602 may relay communication from the parent node 604 to a remote UE 606. In some aspects, for the IAB node 602, operation parameter coordination may be used to facilitate simultaneous operations of the IAB-mobile termination (IAB-MT) link (i.e., the link between the IAB node 602 and the parent node 604) and the IAB-DU link (i.e., the link between the IAB node 602 and the remote UE 606). In different configurations, the simultaneous operations may include one of transmissions in both the IAB-MT link and the IAB-DU link, receptions in both the IAB-MT link and the IAB-DU link, reception in the IAB-MT link and transmission in the IAB-DU link, or transmission in the IAB-MT link and reception in the IAB-DU link. In different configurations, the coordinated parameters may include one or more of power, a beam, or timing in both directions of the IAB-MT link and of the IAB-DU link.

In some aspects, to mitigate the SI between the IAB-DU and the IAB-MT, beam coordination may be used between IAB-MT and IAB-DU links. In particular, at 610, the IAB node 602 may indicate, to the parent node 604, the IAB node 602—recommended (selected) IAB-MT DL/UL beams. Further, at 608, the parent node 604 may indicate, to the IAB node 602, the restricted IAB-DU DL/UL beams.

In some aspects, for a network-controlled repeater (NCR), the network may control one or more of power, beams, timing in access, backhaul links, or control links of the repeater. Further, the network may also implicitly control the on/off states of the repeater via beam indications and the corresponding time resources.

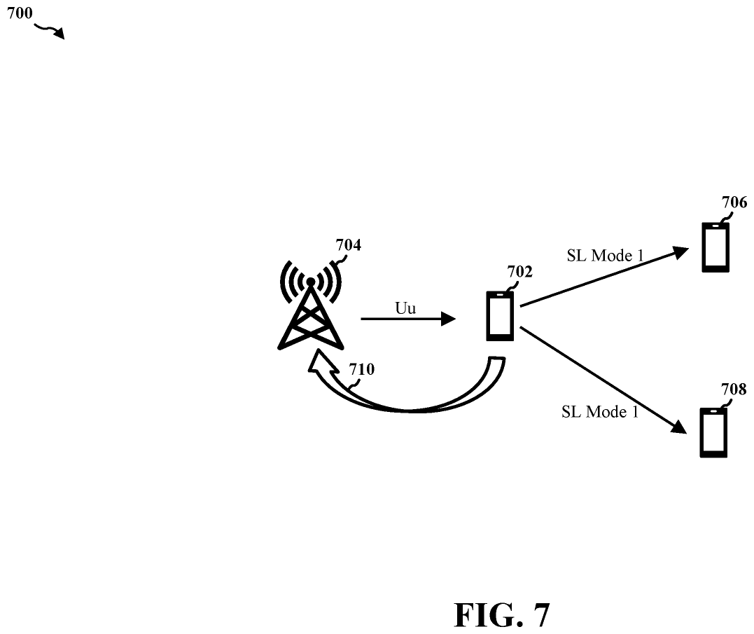

FIG. 7 is a diagram 700 illustrating an example FD relaying operation at a UE according to one or more aspects. As shown, a relay UE 702 may receive communication from a network node 704 via a Uu link, and may relay the communication from the network node 704 to a first remote UE 706 via a first sidelink and to a second remote UE 708 via second sidelink. Both sidelinks may operate in Mode 1. In some configurations, at 710, the relay UE 702 may dynamically inform the network node 704 of whether FD relaying is feasible at the relay UE 702 in the forward direction (i.e., in the network node-to-remote UE direction), where FD relaying in the forward direction may include, at the relay UE 702, simultaneous reception in the downlink (from the network node 704) via the Uu link and relay transmission in the sidelink (to one or more remote UEs 706/708). In one configuration, if the FD relaying is feasible, to assist the network node 704 in the scheduling of the FD transmissions in the Uu link and the sidelink(s), at 710, the relay UE 702 may further indicate, to the network node 704, relay UE 702—recommended scheduling information for the Uu link and/or the sidelink(s). For example, for the sidelink(s), the UE 702—recommended scheduling information may include a recommended number of sidelink grants that may be co-scheduled with a particular Uu downlink beam. Accordingly, the information transmitted at 710 from the relay UE 702 to the network node 704 may be transmitted in an FD relay assistance information message.

Accordingly, the relay UE may dynamically report, to the network, whether FD relaying is feasible in light of the varying environment. Such feasibility reports may not be used for the IAB node case or the NCR case because the IAB node and the NCR may be less affected by the varying environment as they may be placed at optimized relay locations with satisfactory isolation. Further, the relay UE may indicate, to the network, the relay UE-recommended scheduling information for the sidelink(s) for the UE FD relay operation. In particular, the relay UE may recommend a number of sidelink grants that may be co-scheduled with a Uu downlink beam. On the other hand, for the IAB node case, the IAB-DU may not inform the parent node (e.g., the parent IAB node) about how to schedule the transmissions to the remote UEs because the transmissions to the remote UEs may be scheduled by the IAB-DU itself. Further, an amplify-and-forward (A&F) repeater may not know the amount of buffered data per remote UE. Therefore, the A&F repeater may not provide any recommendation about how the communications to the remote UEs may be scheduled.

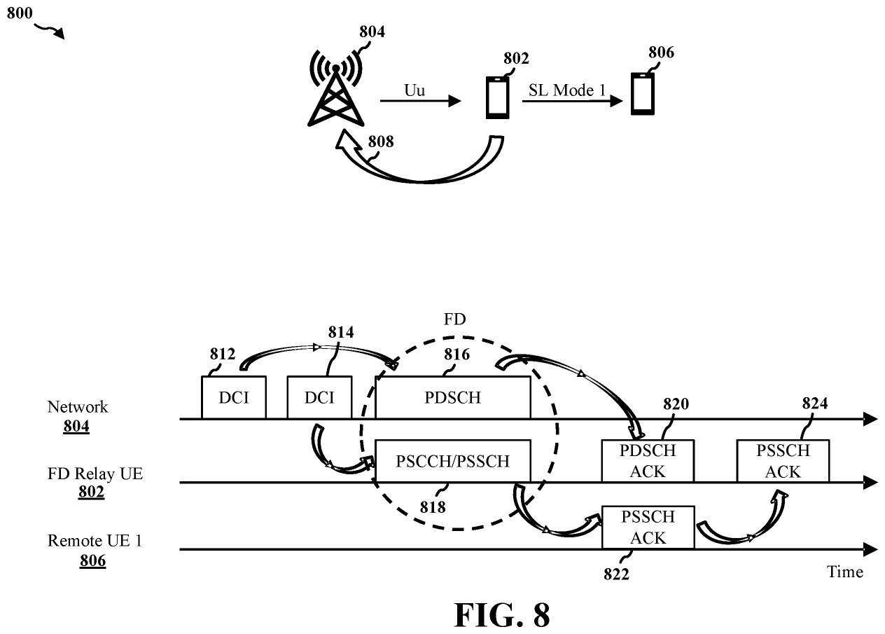

FIG. 8 is a diagram 800 illustrating an example FD relaying operation at a UE according to one or more aspects. As shown, the relay UE 802 may correspond to the relay UE 702 in FIG. 7. The network node 804 may correspond to the network node 704 in FIG. 7. The first remote UE 806 may correspond to the first remote UE 706 in FIG. 7. Further, the FD relay assistance information message transmitted at 808 may be similar to the FD relay assistance information message transmitted at 710 in FIG. 7. Moreover, at 812, the network node 804 may transmit a first DCI message to schedule a transmission by the network node 804 of a PDSCH, which may take place at 816. Further, at 814, the network node 804 may transmit a second DCI message to schedule a transmission by the relay UE 802 of a PSCCH and/or PSSCH (e.g., a PSCCH/PSSCH block), which may take place at 818. At 820, the relay UE 802 may transmit, for the network node 804, a HARQ-ACK feedback associated with the PDSCH at 816. Further, at 822, the first remote UE 806 may transmit, for the relay UE 802, a HARQ-ACK feedback associated with the PSSCH at 818. Moreover, at 824, the relay UE 802 may forward the HARQ-ACK feedback received from the first remote UE 806 at 822 (i.e., the HARQ-ACK feedback associated with the PSSCH at 818) to the network node 804. Based on the HARQ-ACK feedback from the first remote UE 806, the network node 804 may know if the sidelink transmission at 818 to the first remote UE 806 was not successful, in which case the network node 804 may configure repeat sidelink transmissions from the relay UE 802 for the first remote UE 806.

In some aspects, at 808, the relay UE 802 may provide the FD relay assistance information to assist the network node 804 in the scheduling of FD transmission and reception in the Uu link and the sidelink. In particular, in the FD relay assistance information message at 808, the relay UE 802 may indicate whether the FD network node-to-remote UE relaying is feasible. If the FD relaying is feasible, the relay UE 802 may recommend, also in the FD relay assistance information message at 808, a number of sidelink grants whose corresponding sidelink transmissions (e.g., PSCCH/PSSCH transmission at 818) may be FD'ed at the relay UE 802 with the downlink reception in the Uu link (e.g., PDSCH reception at 816).

Although FIG. 8 illustrates just a single sidelink grant for the first remote UE 806, in some different configurations, the network node 804 may actually schedule multiple sidelink grants for the relay UE 802 to transmit, in sidelinks, to multiple remote UEs simultaneously with the downlink reception in the Uu link.

Moreover, for each sidelink grant associated with the FD relaying operation, the relay UE 802 may recommend further scheduling information. The relay UE 802—recommended scheduling information for the sidelink(s) may be included in the FD relay assistance information message at 808. In one configuration, the relay UE 802—recommended scheduling information for the sidelink(s) may include the sidelink time/frequency resource per sidelink grant. In particular, the sidelink time/frequency resource per sidelink grant may be indicated relative to (with reference to) the resource allocated for the downlink grant in the Uu link. For example, the relay UE 802—recommended scheduling information for the sidelink(s) may include an indication of whether the resources for the sidelink and the Uu link may be non-overlapping, partially overlapping, or fully overlapping in frequency. In further examples, if the resources are to be non-overlapping in frequency, the relay UE 802—recommended scheduling information for the sidelink(s) may further include a specification of a guard band between the resource(s) for the Uu link and the resource(s) for the sidelink(s). Moreover, if the resources are to be partially overlapping in frequency, the relay UE 802—recommended scheduling information for the sidelink(s) may further include an indication of the number of RBs that may be allowed to overlap in frequency between the resource(s) for the Uu link and the resource(s) for the sidelink(s).

In another configuration, the relay UE 802—recommended scheduling information for the sidelink(s) may further include one or more of sidelink Tx timing, a power, one or more beam identifiers (ID), one or more transmission configuration indicator (TCI) state IDs, a rank, a precoding matrix, or a multi-TRP (mTRP) scheme for the allocated resource per sidelink grant. For example, the sidelink Tx timing may be aligned with the Uu Rx timing to mitigate SI at the relay UE 802. In some aspects, adaptations may be made to enable the network node 804 to control at least some of the above-described sidelink parameters in communications in the sidelink Mode 1.

In yet another configuration, the relay UE 802—recommended scheduling information for the sidelink(s) may further include a remote UE ID per sidelink grant and the amount of buffered data at the relay UE 802 for this remote UE. Accordingly, based on the indication of the amount of buffered data at the relay UE 802 for the particular remote UE, the network node 804 may keep scheduling sidelink grants (e.g., as a periodic grant) for the remote UE until the buffered data for the remote UE are emptied (cleaned) at the relay UE 802 (i.e., the relay UE 802 has transmitted all the buffered data to the remote UE).

In some configurations, if the FD relaying is feasible, the relay UE 802 may recommend, also in the FD relay assistance information message at 808, the scheduling information for the downlink transmission at the network node 804, e.g., to ensure that the downlink reception at the relay UE 802 may tolerate the SI caused by the sidelink transmission. In one configuration, the relay UE 802—recommended scheduling information for the downlink may include one or more of a downlink time/frequency resource, a downlink Tx power, or downlink Tx timing. In another configuration, the relay UE 802—recommended scheduling information for the downlink may include downlink MIMO parameters. In particular, the downlink MIMO parameters may include one or more of a rank, a precoding matrix, one or more downlink beam IDs, or one or more downlink TCI state IDs. In yet another configuration, the relay UE 802—recommended scheduling information for the downlink may include a downlink mTRP scheme. For example, the downlink mTRP scheme may be single-DCI or multi-DCI based, and may be based on spatial division multiplexing (SDM) or frequency division multiplexing (FDM).

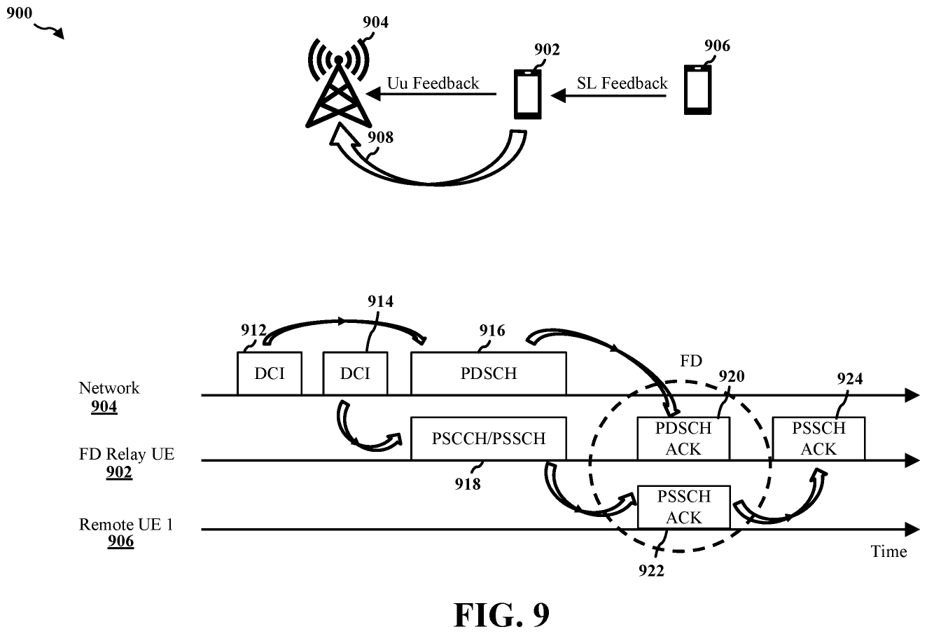

FIG. 9 is a diagram 900 illustrating an example FD relaying operation at a UE according to one or more aspects. As shown, the relay UE 902 may correspond to the relay UE 802 in FIG. 8. The network node 904 may correspond to the network node 804 in FIG. 8. The first remote UE 906 may correspond to the first remote UE 806 in FIG. 8. Further, the FD relay assistance information message transmitted at 908 may be similar to the FD relay assistance information message transmitted at 808 in FIG. 8. Moreover, 912, 914, 916, 918, 920, 922, and 924 may correspond to 812, 814, 816, 818, 820, 822, and 824, respectively.

In some aspects, in addition to performing FD relaying in the forward direction and reporting the feasibility of the FD relaying in the forward direction to the network node 904, the relay UE 902 may also report, to the network node 904, whether FD relaying is feasible for the corresponding HARQ-ACK feedback in the Uu link (e.g., at 920, from the relay UE 902 to the network node 904) and the HARQ-ACK feedback in the sidelink (e.g., at 922, from the first remote UE 906 to the relay UE 902) in the reverse direction. In some configurations, the indication of whether the FD relaying is feasible in the reverse direction for the HARQ-ACK feedback may be included in the FD relay assistance information message at 908. As shown, the HARQ-ACK feedback in the Uu link, at 920, may correspond to the PDSCH at 916 from the network node 904 to the relay UE 902. Further, the HARQ-ACK feedback in the sidelink, at 922, may correspond to the PSSCH at 918 from the relay UE 902 to the first remote UE 906.

In some aspects, the FD relaying feasibility in the reverse direction may not be inferred from the FD relaying feasibility in the forward direction because the relaying in the two opposite directions may be associated with different Tx powers, different Tx/Rx beams, and/or different resource allocations, etc.

In one or more configurations, if the FD relaying in the reverse direction for the HARQ-ACK feedback is feasible, the relay UE 902 may further recommend scheduling information for the simultaneous HARQ-ACK feedback transmission in the Uu link and HARQ-ACK feedback transmission in the sidelink (e.g., per sidelink grant). The relay UE 902—recommended scheduling information for the simultaneous HARQ-ACK feedback transmissions may be included in the FD relay assistance information message at 908. In one configuration, the relay UE 902—recommended scheduling information for the simultaneous HARQ-ACK feedback transmissions may include one or more of a time/frequency resource, Tx timing, a power, one or more beam IDs, or one or more TCI state IDs, etc.

In different configurations, the relay UE may transmit (e.g., at 808/908), for the network node, the FD relay assistance information message in different manners. In one configuration, the relay UE may transmit the FD relay assistance information message in a network node-scheduled report. For example, the network node-scheduled report may be a periodic report, a semi-persistent report based on semi-persistent scheduling, or an aperiodic report. In one configuration, the network node-scheduled report may reuse the channel state information (CSI) framework (e.g., similar to CSI reports). In another configuration, the relay UE may transmit the FD relay assistance information message based on a triggering event (or autonomously) (e.g., the triggering event may be an event that may occur at the relay UE). In particular, the event-triggered (or autonomous) FD relay assistance information message may be carried (transmitted) in a UCI message or a MAC-control element (MAC-CE).

If the relay UE transmits the FD relay assistance information message based on a triggering event, the triggering event(s) and/or the threshold(s) may be configured by the network node. An example triggering event including an associated threshold may be that the SI caused by at least one sidelink transmission to at least one downlink reception is less than a specified threshold. Another example triggering event including an associated threshold may be that the signal-to-interference-plus-noise ratio (SINR) of a downlink reception taking into consideration the SI from a sidelink transmission is greater than a specified threshold. In one configuration, the UCI message or the MAC-CE carrying the FD relay assistance information message may be associated with a priority (e.g., when the UCI message or the MAC-CE carrying the FD relay assistance information message is multiplexed with other UCI message or MAC-CE types).

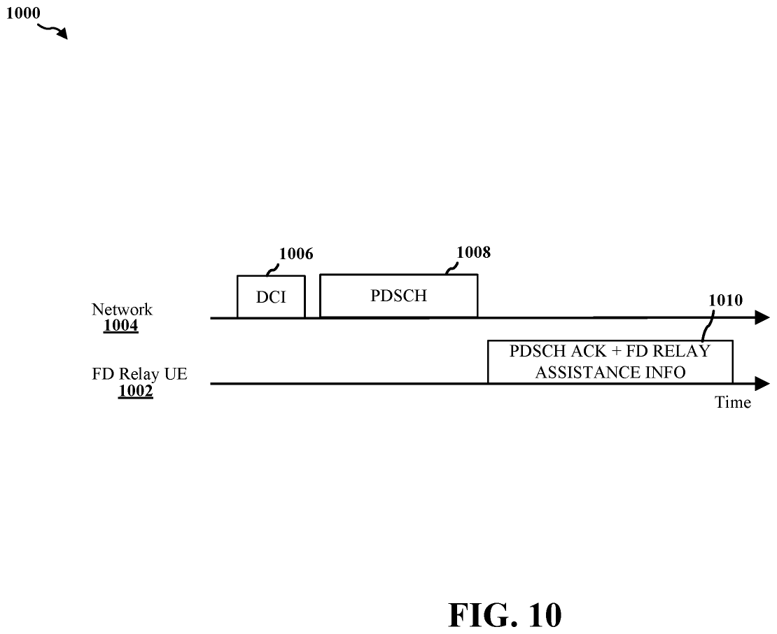

FIG. 10 is a diagram 1000 illustrating the transmission of an example FD relay assistance information message according to one or more aspects. In some configurations, at 1010, the relay UE 1002 may transmit, for the network node 1004, the FD relay assistance information message together with a HARQ-ACK feedback for a downlink reception in the Uu link (e.g., the reception of the PDSCH 1008, where the PDSCH 1008 may be scheduled by the DCI message 1006). For example, a simple 1-bit indicator may be appended to the HARQ-ACK feedback to indicate that (at least) one sidelink transmission may be FD'ed with the downlink reception. Accordingly, based on this indicator, the network node 1004 may allocate one sidelink grant that is FD'ed with such a downlink reception for future communications. In another example, a multi-bit indicator may be appended to the HARQ-ACK feedback to indicate the number of sidelink grants that may be FD'ed with such a downlink reception. In still further examples, any information that may be included in the FD relay assistance information message, as described above, may be appended to the HARQ-ACK feedback.

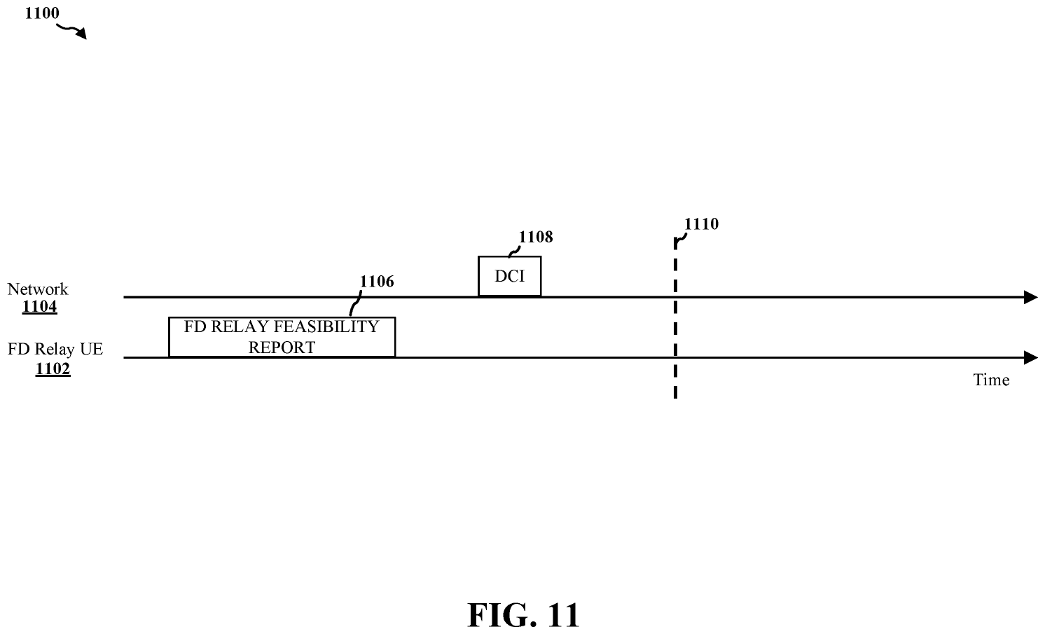

FIG. 11 is a diagram 1100 illustrating an example application time associated with FD relaying according to one or more aspects. In some configurations, if the relay UE 1102 determines that FD relaying is feasible or infeasible (if FD relaying is infeasible, half-duplex (HD) relaying may be performed instead where the relay UE may not transmit and receive at the same time) and report, at 1106, the feasibility of the FD relaying to the network node 1104, the relay UE 1102 may also specify (define) an application time 1110 and indicate the application time 1110 in the FD relay assistance information message at 1106, such that the network node 1104 may schedule communication based on the appropriate relaying mode (e.g., FD relaying if FD relaying is feasible and HD relaying if FD relaying is infeasible) after the application time 1110 has passed. In some other configurations, the application time 1110 may be configured by the network node 1104. In particular, for example, the network node 1104 may transmit an indication of the application time 1110 to the relay UE 1102 via one of an RRC message, a MAC-CE, or a DCI message. For example, if the relay UE 1102 indicates that FD relaying becomes infeasible, the network node 1104 may not schedule simultaneous (overlapping in time) downlink reception in the Uu link and sidelink transmission at the relay UE 1102 after the application time 1110 has passed. In different configurations, the application time 1110 may be indicated with reference to a number of symbols (e.g., X symbols) or absolute time (e.g., X ms) (e.g., after a certain event). For example, the application time 1110 may be X symbols or X ms after the end of the transmission at 1106 carrying the FD relay assistance information message, or after a corresponding acknowledgement from the network node 1104 (i.e., acknowledgement corresponding to the transmission at 1106). For example, the corresponding acknowledgement from the network node 1104 may be a DCI message at 1108 scheduling a new uplink grant with the same HARQ ID as that of the MAC-CE carrying the FD relay assistance information message at 1106.

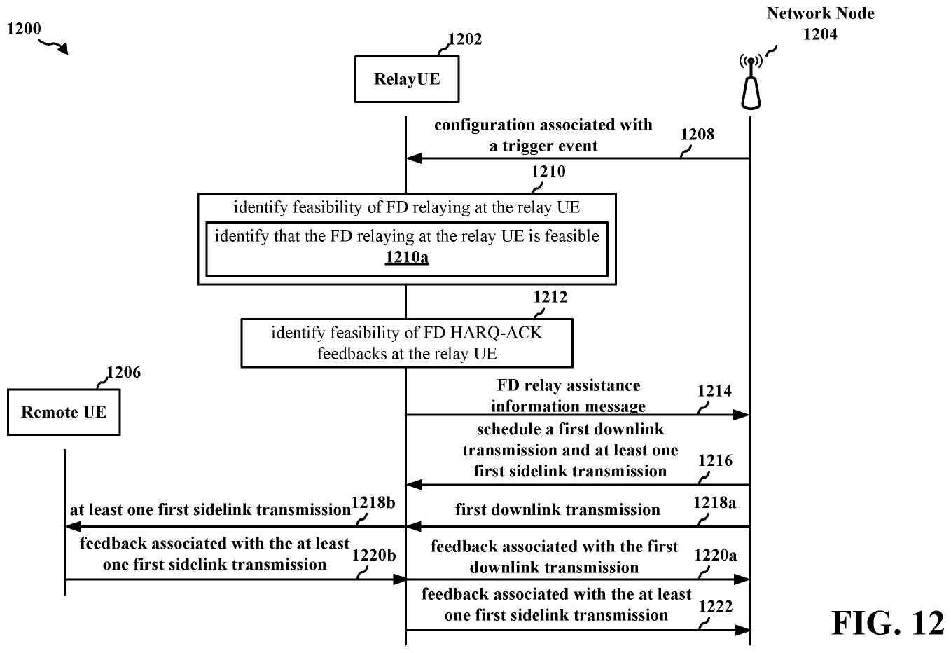

FIG. 12 is a diagram of a communication flow 1200 of a method of wireless communication. The relay UE 1202 may implement aspects of the relay UE 104/350/502/702/802/902/1002/1102. The network node 1204 may implement aspects of the base station 102/310 or the network node 504/704/804/904/1004/1104. The remote UE 1206 may implement aspects of the (first) remote UE 506/706/806/906. As shown, in one configuration, at 1208, the network node 1204 may transmit, for the relay UE 1202, a configuration associated with a trigger event. As will be described in further detail below, in some aspects, the relay UE 1202 may transmit, at 1214, for the network node 1204, an FD relay assistance information message via a UCI message or a MAC-CE based on the trigger event as configured at 1208.

At 1210, the relay UE 1202 may identify feasibility of FD relaying at the relay UE 1202 (i.e., the relay UE 1202 may identify whether the FD relaying at the relay UE 1202 is feasible or infeasible) (e.g., based on one or more of FD performance metrics, the environment, or FD operation-related configurations at the relay UE 1202, etc.). The FD relaying at the relay UE 1202 may include simultaneous downlink reception from the network node 1204 and sidelink transmission to the remote UE 1206.

In one configuration, at 1210a, the relay UE 1202 may identify that the FD relaying at the relay UE 1202 is feasible.

In one configuration, at 1212, the relay UE 1202 may identify feasibility of FD HARQ-ACK feedback at the relay UE 1202 (i.e., the relay UE 1202 may identify whether FD'ed HARQ-ACK feedback at the relay UE 1202 are feasible). The FD HARQ-ACK feedback at the relay UE 1202 may include simultaneous HARQ-ACK feedback associated with a first downlink transmission from the network node 1204 to the relay UE 1202 and at least one first sidelink transmission from the relay UE 1202 to the remote UE 1206.

At 1214, the relay UE 1202 may transmit, for the network node 1204, an FD relay assistance information message based on the identified feasibility of the FD relaying at the relay UE 1202.

In one configuration, the FD relay assistance information message at 1214 may include an indication that the FD relaying at the relay UE 1202 is feasible (e.g., based on the FD relaying at the relay UE 1202 being identified at 1210a as being feasible).

In one configuration, the FD relay assistance information message at 1214 may further includes an indication of a relay UE 1202—recommended number of sidelink grants associated with the FD relaying at the relay UE 1202. For example, based on multiple sidelink grants, the relay UE 1202 may transmit, at 1218b, multiple sidelink transmissions that are FD'ed with the reception of the downlink transmission at 1218a.

In one configuration, the FD relay assistance information message at 1214 may further include one or more indications of one or more relay UE 1202—recommended parameters for at least one sidelink grant associated with the FD relaying at the relay UE 1202. The one or more relay UE 1202—recommended parameters for the at least one sidelink grant may include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE 1202 for the remote UE. In configurations where there is more than one remote UE, each remote UE may be identified (e.g., for indicating the corresponding amount of buffered data) in the FD relay assistance information message at 1214 based on a respective remote UE ID associated with the remote UE.

In one configuration, the FD relay assistance information message at 1214 may further include one or more indications of one or more relay UE 1202—recommended parameters for a downlink transmission associated with the FD relaying at the relay UE 1202. The one or more relay UE 1202—recommended parameters for the downlink transmission may include at least one of a downlink time/frequency resource, a downlink transmission power, a downlink transmission timing, or one or more downlink MIMO parameters.

In one configuration, the one or more downlink MIMO parameters may include at least one of a rank, a precoding matrix, a downlink beam ID, a downlink TCI state ID, or a downlink mTRP scheme.

In one configuration, the FD relay assistance information message may further include an indication of the identified feasibility of the FD HARQ-ACK feedback (e.g., as identified at 1212).

In one configuration where the FD HARQ-ACK feedback are identified at 1212 as being feasible, the FD relay assistance information message at 1214 may further include one or more indications of one or more relay UE 1202—recommended parameters for at least one HARQ-ACK feedback associated with the FD HARQ-ACK feedback at the relay UE. The one or more relay UE 1202—recommended parameters for the at least one HARQ-ACK feedback may include at least one of a time/frequency resource, a transmission timing, a transmission power, a beam ID, or a TCI state ID.

In one configuration, the FD relay assistance information message may be transmitted, at 1214, by the relay UE 1202 based on one of periodic scheduling, semi-persistent scheduling, or aperiodic scheduling.

In one configuration, the FD relay assistance information message may be transmitted, at 1214, by the relay UE 1202 via a UCI message or a MAC-CE based on the trigger event (occurring) at the relay UE 1202 (the configuration associated with the trigger event may be provided by the network node 1204 at 1208).

In one configuration, the FD relay assistance information message may be transmitted, at 1214, by the relay UE 1202 via a HARQ-ACK feedback associated with a downlink transmission.

In one configuration, the FD relay assistance information message at 1214 may further include an indication of an application time associated with the identified feasibility of the FD relaying.

In one configuration, at 1216, the network node 1204 may schedule a first downlink transmission from the network node 1204 to the relay UE 1202 and at least one first sidelink transmission from the relay UE 1202 to the remote UE 1206 based on the FD relay assistance information message at 1214.

In one configuration, at 1218a, the relay UE 1202 may receive a first downlink transmission from the network node 1204 based on the FD relay assistance information message at 1214 and the scheduling at 1216. At 1218b, the relay UE 1202 may transmit at least one first sidelink transmission to the remote UE 1206 based on the FD relay assistance information message at 1214 and the scheduling at 1216. 1218a and 1218b may be performed by the relay UE 1202 simultaneously. In other words, the reception in the downlink at 1218a and the transmission in the sidelink at 1218b may be FD'ed.

In one configuration, at 1220a, the relay UE 1202 may transmit, for the network node 1204, a HARQ-ACK feedback (e.g., an ACK/NACK) associated with the first downlink transmission at 1218a. At 1220b, the relay UE 1202 may receive a HARQ-ACK feedback (e.g., an ACK/NACK) associated with the at least one first sidelink transmission at 1218b from the remote UE 1206. 1220a and 1220b may be performed by the relay UE 1202 simultaneously (e.g., if the FD HARQ-ACK feedback are identified at 1212 as being feasible).

In one configuration, at 1222, the relay UE 1202 may forward the HARQ-ACK feedback received from the remote UE 1206 at 1220b (i.e., the HARQ-ACK feedback associated with the first sidelink transmission at 1218b) to the network node 1204. Based on the HARQ-ACK feedback from the remote UE 1206, the network node 1204 may know if the sidelink transmission at 1218b to the remote UE 1206 was not successful, in which case the network node 1204 may configure further sidelink transmissions and/or repeat sidelink transmissions (i.e., re-transmissions) from the relay UE 1202 for the remote UE 1206.

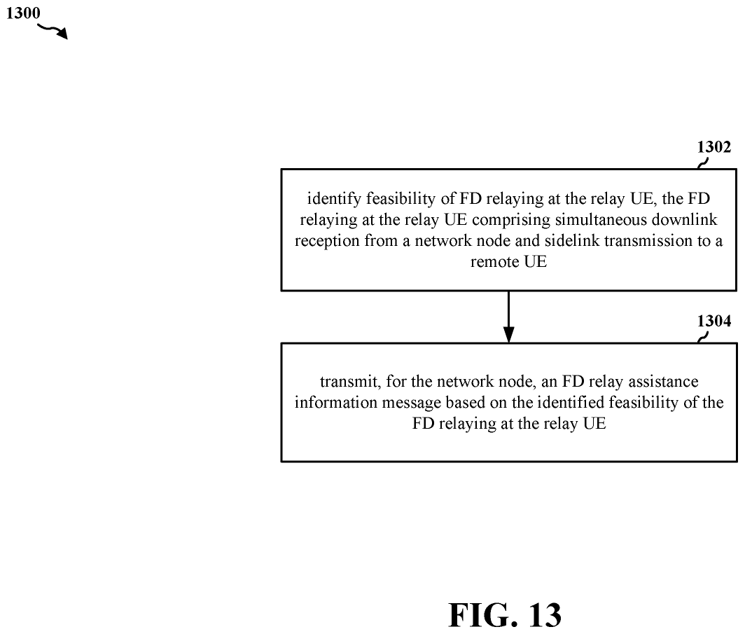

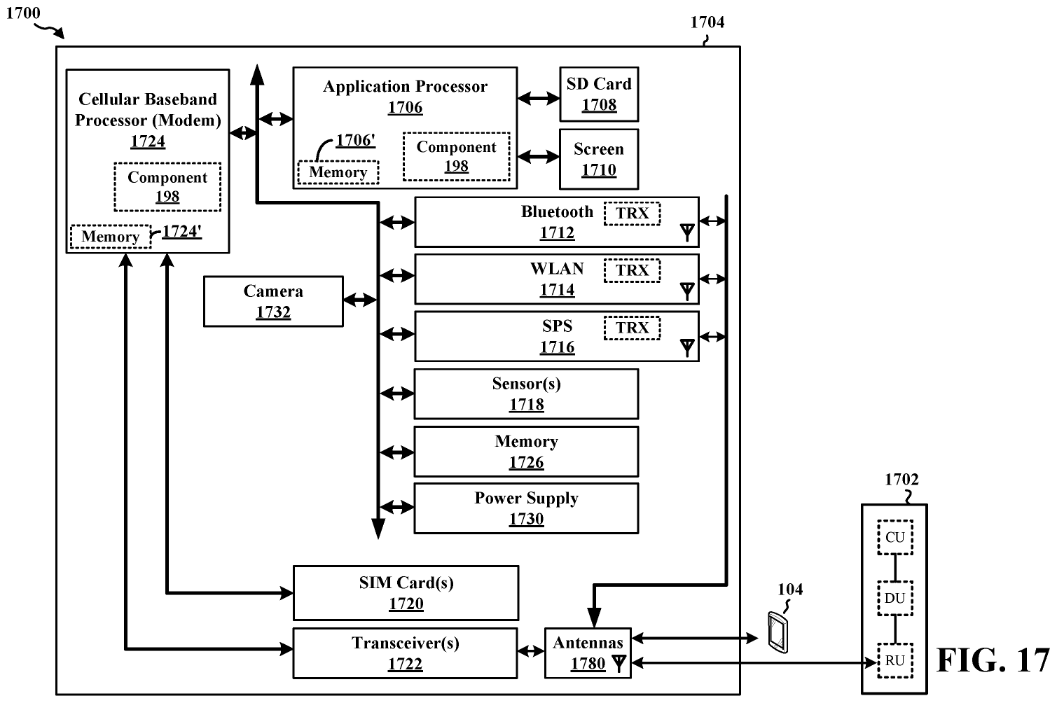

FIG. 13 is a flowchart 1300 of a method of wireless communication. The method may be performed by a UE (e.g., relay the relay UE 104/350/502/702/802/902/1002/1102/1202; the apparatus 1704). At 1302, the relay UE may identify feasibility of FD relaying at the relay UE. The FD relaying at the relay UE may include simultaneous downlink reception from a network node and sidelink transmission to a remote UE. For example, 1302 may be performed by the component 198 in FIG. 17. Referring to FIG. 12, at 1210, the relay UE 1202 may identify feasibility of FD relaying at the relay UE 1202.

At 1304, the relay UE may transmit, for the network node, an FD relay assistance information message based on the identified feasibility of the FD relaying at the relay UE. For example, 1304 may be performed by the component 198 in FIG. 17. Referring to FIG. 12, at 1214, the relay UE 1202 may transmit, for the network node 1204, an FD relay assistance information message based on the identified feasibility of the FD relaying at the relay UE 1202.

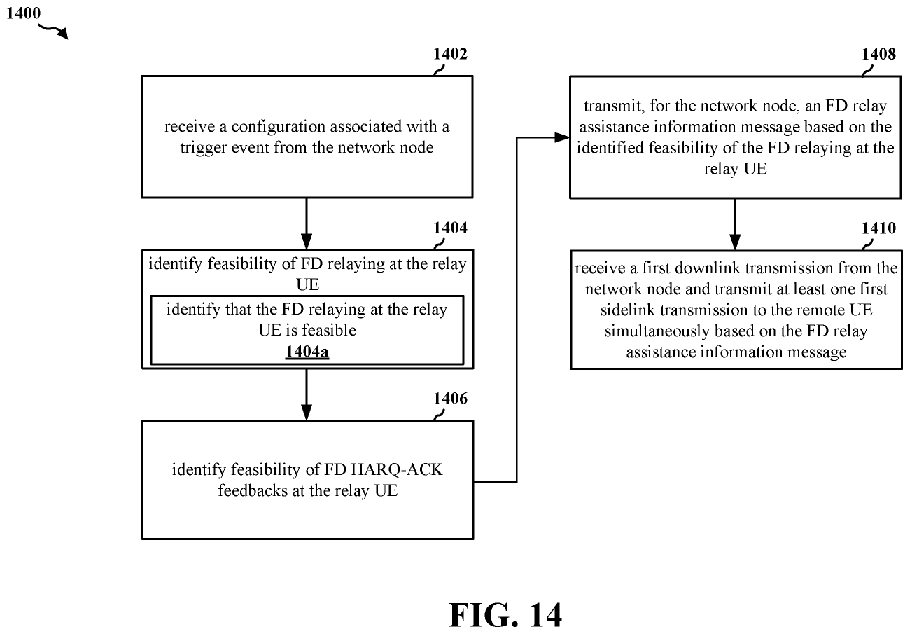

FIG. 14 is a flowchart 1400 of a method of wireless communication. The method may be performed by a relay UE (e.g., the relay UE 104/350/502/702/802/902/1002/1102/1202; the apparatus 1704). At 1404, the relay UE may identify feasibility of FD relaying at the relay UE. The FD relaying at the relay UE may include simultaneous downlink reception from a network node and sidelink transmission to a remote UE. For example, 1404 may be performed by the component 198 in FIG. 17. Referring to FIG. 12, at 1210, the relay UE 1202 may identify feasibility of FD relaying at the relay UE 1202.

At 1408, the relay UE may transmit, for the network node, an FD relay assistance information message based on the identified feasibility of the FD relaying at the relay UE. For example, 1408 may be performed by the component 198 in FIG. 17. Referring to FIG. 12, at 1214, the relay UE 1202 may transmit, for the network node 1204, an FD relay assistance information message based on the identified feasibility of the FD relaying at the relay UE 1202.

In one configuration, to identify, at 1404, the feasibility of the FD relaying at the relay UE, at 1404a, the relay UE may identify that the FD relaying at the relay UE is feasible. The FD relay assistance information message may include an indication that the FD relaying at the relay UE is feasible. For example, 1402a may be performed by the component 198 in FIG. 17. Referring to FIG. 12, at 1210a, the relay UE 1202 may identify that the FD relaying at the relay UE 1202 is feasible.

In one configuration, referring to FIG. 12, the FD relay assistance information message at 1214 may further include an indication of a relay UE-recommended number of sidelink grants associated with the FD relaying at the relay UE 1202.

In one configuration, referring to FIG. 12, the FD relay assistance information message at 1214 may further include one or more indications of one or more relay UE-recommended parameters for at least one sidelink grant associated with the FD relaying at the relay UE 1202. The one or more relay UE-recommended parameters for the at least one sidelink grant may include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE 1202 for the remote UE 1206.

In one configuration, referring to FIG. 12, the FD relay assistance information message at 1214 may further include one or more indications of one or more relay UE-recommended parameters for a downlink transmission associated with the FD relaying at the relay UE 1202. The one or more relay UE-recommended parameters for the downlink transmission may include at least one of a downlink time/frequency resource, a downlink transmission power, a downlink transmission timing, or one or more downlink MIMO parameters.

In one configuration, the one or more downlink MIMO parameters may include at least one of a rank, a precoding matrix, a downlink beam ID, a downlink TCI state ID, or a downlink mTRP scheme.

In one configuration, at 1406, the relay UE may identify feasibility of FD HARQ-ACK feedback at the relay UE. The FD HARQ-ACK feedback at the relay UE may include simultaneous HARQ-ACK feedback associated with a first downlink transmission from the network node and at least one first sidelink transmission from the relay UE. The FD relay assistance information message may further include an indication of the identified feasibility of the FD HARQ-ACK feedback. For example, 1406 may be performed by the component 198 in FIG. 17. Referring to FIG. 12, at 1212, the relay UE 1202 may identify feasibility of FD HARQ-ACK feedback at the relay UE 1202.

In one configuration, referring to FIG. 12, the FD relay assistance information message at 1214 may further include one or more indications of one or more relay UE-recommended parameters for at least one HARQ-ACK feedback associated with the FD HARQ-ACK feedback at the relay UE 1202. The one or more relay UE-recommended parameters for the at least one HARQ-ACK feedback may include at least one of a time/frequency resource, a transmission timing, a transmission power, a beam ID, or a TCI state ID.

In one configuration, referring to FIG. 12, the FD relay assistance information message may be transmitted at 1214 based on one of periodic scheduling, semi-persistent scheduling, or aperiodic scheduling.

In one configuration, at 1402, the relay UE may receive a configuration associated with a trigger event from the network node. The FD relay assistance information message may be transmitted via a UCI message or a MAC-CE based on the trigger event occurring at the relay UE. For example, 1402 may be performed by the component 198 in FIG. 17. Referring to FIG. 12, at 1208, the relay UE 1202 may receive a configuration associated with a trigger event from the network node 1204. In one configuration, referring to FIG. 12, the FD relay assistance information message may be transmitted at 1214 via a HARQ-ACK feedback associated with a downlink transmission.

In one configuration, referring to FIG. 12, the FD relay assistance information message at 1214 may further include an indication of an application time associated with the identified feasibility of the FD relaying.

In one configuration, at 1410, the relay UE may receive a first downlink transmission from the network node and transmit at least one first sidelink transmission to the remote UE simultaneously based on the FD relay assistance information message. For example, 1410 may be performed by the component 198 in FIG. 17. Referring to FIGS. 12, at 1218a and 1218b, the relay UE 1202 may receive a first downlink transmission from the network node 1204 and transmit at least one first sidelink transmission to the remote UE 1206 simultaneously based on the FD relay assistance information message at 1214.

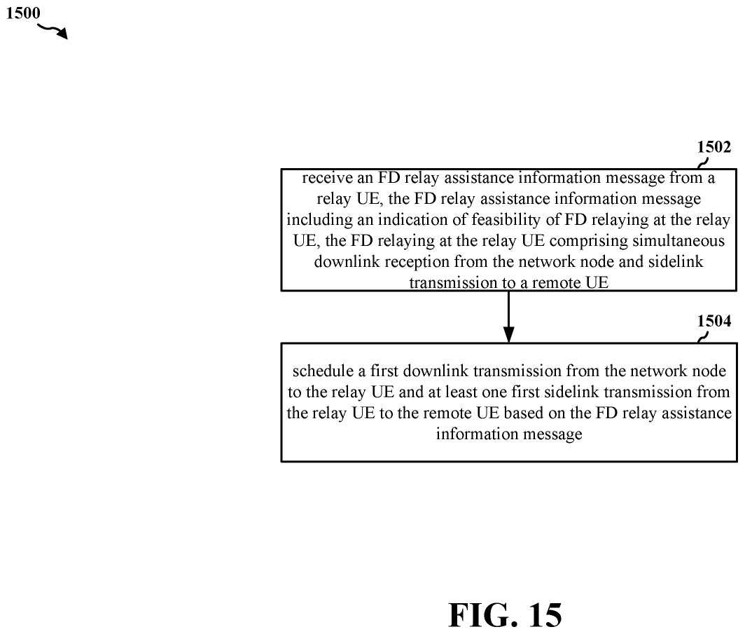

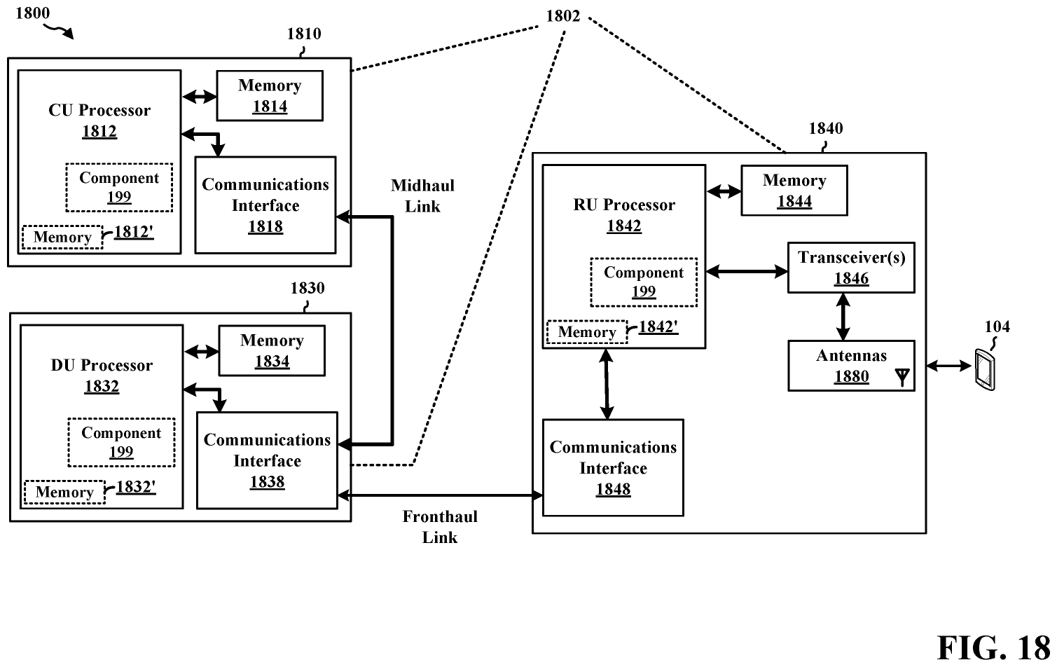

FIG. 15 is a flowchart 1500 of a method of wireless communication. The method may be performed by a network node (e.g., the base station 102/310; the network node 504/704/804/904/1004/1104/1204; the network entity 1702, 1802). At 1502, the network node may receive an FD relay assistance information message from a relay UE. The FD relay assistance information message may include an indication of feasibility of FD relaying at the relay UE. The FD relaying at the relay UE may include simultaneous downlink reception from the network node and sidelink transmission to a remote UE. For example, 1502 may be performed by the component 199 in FIG. 18. Referring to FIG. 12, at 1214, the network node 1204 may receive an FD relay assistance information message from a relay UE 1202.

At 1504, the network node may schedule a first downlink transmission from the network node to the relay UE and at least one first sidelink transmission from the relay UE to the remote UE based on the FD relay assistance information message. For example, 1504 may be performed by the component 199 in FIG. 18. Referring to FIG. 12, at 1216, the network node 1204 may schedule a first downlink transmission from the network node 1204 to the relay UE 1202 and at least one first sidelink transmission from the relay UE 1202 to the remote UE 1206 based on the FD relay assistance information message at 1214.

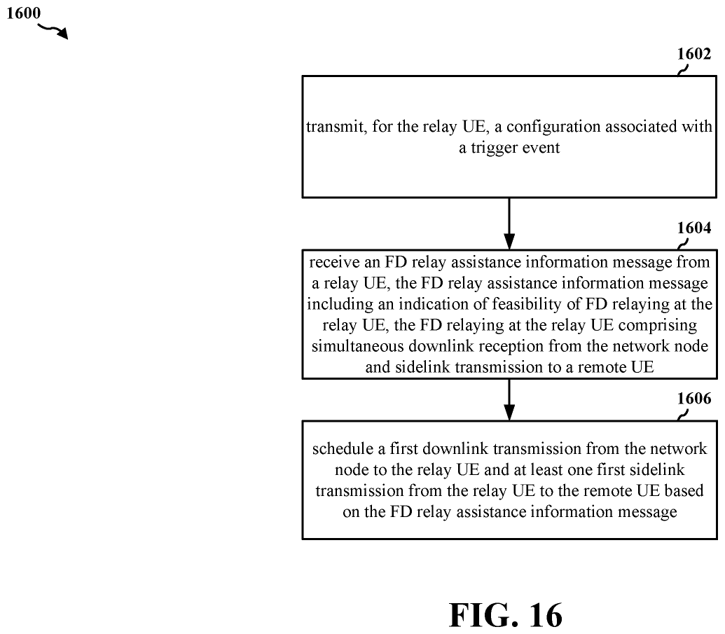

FIG. 16 is a flowchart 1600 of a method of wireless communication. The method may be performed by a network node (e.g., the base station 102/310; the network node 504/704/804/904/1004/1104/1204; the network entity 1702, 1802). At 1604, the network node may receive an FD relay assistance information message from a relay UE. The FD relay assistance information message may include an indication of feasibility of FD relaying at the relay UE. The FD relaying at the relay UE may include simultaneous downlink reception from the network node and sidelink transmission to a remote UE. For example, 1604 may be performed by the component 199 in FIG. 18. Referring to FIG. 12, at 1214, the network node 1204 may receive an FD relay assistance information message from a relay UE 1202.

At 1606, the network node may schedule a first downlink transmission from the network node to the relay UE and at least one first sidelink transmission from the relay UE to the remote UE based on the FD relay assistance information message. For example, 1606 may be performed by the component 199 in FIG. 18. Referring to FIG. 12, at 1216, the network node 1204 may schedule a first downlink transmission from the network node 1204 to the relay UE 1202 and at least one first sidelink transmission from the relay UE 1202 to the remote UE 1206 based on the FD relay assistance information message at 1214.

In one configuration, referring to FIG. 12, the FD relay assistance information message at 1214 may include an indication that the FD relaying at the relay UE 1202 is feasible.

In one configuration, referring to FIG. 12, the FD relay assistance information message at 1214 may further include an indication of a relay UE-recommended number of sidelink grants associated with the FD relaying at the relay UE 1202.

In one configuration, referring to FIG. 12, the FD relay assistance information message at 1214 may further include one or more indications of one or more relay UE-recommended parameters for at least one sidelink grant associated with the FD relaying at the relay UE 1202. The one or more relay UE-recommended parameters for the at least one sidelink grant may include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE 1202 for the remote UE 1206.

In one configuration, referring to FIG. 12, the FD relay assistance information message at 1214 may further include one or more indications of one or more relay UE-recommended parameters for a downlink transmission associated with the FD relaying at the relay UE 1202. The one or more relay UE-recommended parameters for the downlink transmission may include at least one of a downlink time/frequency resource, a downlink transmission power, a downlink transmission timing, or one or more downlink MIMO parameters.

In one configuration, the one or more downlink MIMO parameters may include at least one of a rank, a precoding matrix, a downlink beam ID, a downlink TCI state ID, or a downlink mTRP scheme.

In one configuration, referring to FIG. 12, the FD relay assistance information message at 1214 may further include an indication of feasibility of FD HARQ-ACK feedback at the relay UE 1202. The FD HARQ-ACK feedback at the relay UE 1202 may include simultaneous HARQ-ACK feedback associated with the first downlink transmission from the network node 1204 and the at least one first sidelink transmission from the relay UE 1202.

In one configuration, referring to FIG. 12, the FD relay assistance information message at 1214 may further include one or more indications of one or more relay UE-recommended parameters for at least one HARQ-ACK feedback associated with the FD HARQ-ACK feedback at the relay UE 1202. The one or more relay UE-recommended parameters for the at least one HARQ-ACK feedback may include at least one of a time/frequency resource, a transmission timing, a transmission power, a beam ID, or a TCI state ID.

In one configuration, referring to FIG. 12, the FD relay assistance information message may be received at 1214 based on one of periodic scheduling, semi-persistent scheduling, or aperiodic scheduling.

In one configuration, at 1602, the network node may transmit, for the relay UE, a configuration associated with a trigger event. The FD relay assistance information message may be received via a UCI message or a MAC-CE based on the trigger event occurring at the relay UE. For example, 1602 may be performed by the component 199 in FIG. 18. Referring to FIG. 12, at 1208, the network node 1204 may transmit, for the relay UE 1202, a configuration associated with a trigger event.

In one configuration, referring to FIG. 12, the FD relay assistance information message may be received at 1214 via a HARQ-ACK feedback associated with a downlink transmission.

In one configuration, referring to FIG. 12, the FD relay assistance information message at 1214 may further include an indication of an application time associated with the feasibility of the FD relaying.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to identify feasibility of FD relaying at the relay UE. The FD relaying at the relay UE may include simultaneous downlink reception from a network node and sidelink transmission to a remote UE. The component 198 may be configured to transmit, for the network node, an FD relay assistance information message based on the identified feasibility of the FD relaying at the relay UE. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for identifying feasibility of FD relaying at the relay UE. The FD relaying at the relay UE may include simultaneous downlink reception from a network node and sidelink transmission to a remote UE. The apparatus 1704, and in particular the cellular baseband processor 1724 and/or the application processor 1706, may include means for transmitting, for the network node, an FD relay assistance information message based on the identified feasibility of the FD relaying at the relay UE.

In one configuration, the means for identifying he feasibility of the FD relaying at the relay UE may be further configured to identify that the FD relaying at the relay UE is feasible. The FD relay assistance information message may include an indication that the FD relaying at the relay UE is feasible. In one configuration, the FD relay assistance information message may further include an indication of a relay UE-recommended number of sidelink grants associated with the FD relaying at the relay UE. In one configuration, the FD relay assistance information message may further include one or more indications of one or more relay UE-recommended parameters for at least one sidelink grant associated with the FD relaying at the relay UE. The one or more relay UE-recommended parameters for the at least one sidelink grant may include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE for the remote UE. In one configuration, the FD relay assistance information message may further include one or more indications of one or more relay UE-recommended parameters for a downlink transmission associated with the FD relaying at the relay UE. The one or more relay UE-recommended parameters for the downlink transmission may include at least one of a downlink time/frequency resource, a downlink transmission power, a downlink transmission timing, or one or more downlink MIMO parameters. In one configuration, the one or more downlink MIMO parameters may include at least one of a rank, a precoding matrix, a downlink beam ID, a downlink TCI state ID, or a downlink mTRP scheme. In one configuration, the apparatus 1704, and in particular the cellular baseband processor 1724 and/or the application processor 1706, may include means for identifying feasibility of FD HARQ-ACK feedback at the relay UE. The FD HARQ-ACK feedback at the relay UE may include simultaneous HARQ-ACK feedback associated with a first downlink transmission from the network node and at least one first sidelink transmission from the relay UE. The FD relay assistance information message may further include an indication of the identified feasibility of the FD HARQ-ACK feedback. In one configuration, the FD relay assistance information message may further include one or more indications of one or more relay UE-recommended parameters for at least one HARQ-ACK feedback associated with the FD HARQ-ACK feedback at the relay UE. The one or more relay UE-recommended parameters for the at least one HARQ-ACK feedback may include at least one of a time/frequency resource, a transmission timing, a transmission power, a beam ID, or a TCI state ID. In one configuration, the FD relay assistance information message may be transmitted based on one of periodic scheduling, semi-persistent scheduling, or aperiodic scheduling. In one configuration, the apparatus 1704, and in particular the cellular baseband processor 1724 and/or the application processor 1706, may include means for receiving a configuration associated with a trigger event from the network node. The FD relay assistance information message may be transmitted via a UCI message or a MAC-CE based on the trigger event occurring at the relay UE. In one configuration, the FD relay assistance information message may be transmitted via a HARQ-ACK feedback associated with a downlink transmission. In one configuration, the FD relay assistance information message may further include an indication of an application time associated with the identified feasibility of the FD relaying. In one configuration, the apparatus 1704, and in particular the cellular baseband processor 1724 and/or the application processor 1706, may include means for receiving a first downlink transmission from the network node and transmitting at least one first sidelink transmission to the remote UE simultaneously based on the FD relay assistance information message.

The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive an FD relay assistance information message from a relay UE. The FD relay assistance information message may include an indication of feasibility of FD relaying at the relay UE. The FD relaying at the relay UE may include simultaneous downlink reception from the network node and sidelink transmission to a remote UE. The component 199 may be configured to schedule a first downlink transmission from the network node to the relay UE and at least one first sidelink transmission from the relay UE to the remote UE based on the FD relay assistance information message. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for receiving an FD relay assistance information message from a relay UE. The FD relay assistance information message may include an indication of feasibility of FD relaying at the relay UE. The FD relaying at the relay UE may include simultaneous downlink reception from the network node and sidelink transmission to a remote UE. The network entity 1802 may include means for scheduling a first downlink transmission from the network node to the relay UE and at least one first sidelink transmission from the relay UE to the remote UE based on the FD relay assistance information message.

In one configuration, the FD relay assistance information message may include an indication that the FD relaying at the relay UE is feasible. In one configuration, the FD relay assistance information message may further include an indication of a relay UE-recommended number of sidelink grants associated with the FD relaying at the relay UE. In one configuration, the FD relay assistance information message may further include one or more indications of one or more relay UE-recommended parameters for at least one sidelink grant associated with the FD relaying at the relay UE. The one or more relay UE-recommended parameters for the at least one sidelink grant may include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE for the remote UE. In one configuration, the FD relay assistance information message may further include one or more indications of one or more relay UE-recommended parameters for a downlink transmission associated with the FD relaying at the relay UE. The one or more relay UE-recommended parameters for the downlink transmission may include at least one of a downlink time/frequency resource, a downlink transmission power, a downlink transmission timing, or one or more downlink MIMO parameters. In one configuration, the one or more downlink MIMO parameters may include at least one of a rank, a precoding matrix, a downlink beam ID, a downlink TCI state ID, or a downlink mTRP scheme. In one configuration, the FD relay assistance information message may further include an indication of feasibility of FD HARQ-ACK feedback at the relay UE. The FD HARQ-ACK feedback at the relay UE may include simultaneous HARQ-ACK feedback associated with the first downlink transmission from the network node and the at least one first sidelink transmission from the relay UE. In one configuration, the FD relay assistance information message may further include one or more indications of one or more relay UE-recommended parameters for at least one HARQ-ACK feedback associated with the FD HARQ-ACK feedback at the relay UE. The one or more relay UE-recommended parameters for the at least one HARQ-ACK feedback may include at least one of a time/frequency resource, a transmission timing, a transmission power, a beam ID, or a TCI state ID. In one configuration, the FD relay assistance information message may be received based on one of periodic scheduling, semi-persistent scheduling, or aperiodic scheduling. In one configuration, the network entity 1802 may include means for transmitting, for the relay UE, a configuration associated with a trigger event. The FD relay assistance information message may be received via a UCI message or a MAC-CE based on the trigger event occurring at the relay UE. In one configuration, the FD relay assistance information message may be received via a HARQ-ACK feedback associated with a downlink transmission. In one configuration, the FD relay assistance information message may further include an indication of an application time associated with the feasibility of the FD relaying.

The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

Referring back to FIGS. 4-18, a relay UE may identify feasibility of FD relaying at the relay UE. The FD relaying at the relay UE may include simultaneous downlink reception from a network node and sidelink transmission to a remote UE. The relay UE may transmit, for the network node, an FD relay assistance information message based on the identified feasibility of the FD relaying at the relay UE. The network node may schedule a first downlink transmission from the network node to the relay UE and at least one first sidelink transmission from the relay UE to the remote UE based on the FD relay assistance information message. Accordingly, the described techniques can be used to enable the network node to track whether FD relaying is feasible at the relay UE and schedule communications accordingly without incurring communication overhead and/or latency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a relay UE, including identifying a feasibility of FD relaying at the relay UE, the FD relaying at the relay UE including simultaneous downlink reception from a network node and sidelink transmission to a remote UE; and transmitting, for the network node, an FD relay assistance information message based on the identified feasibility of the FD relaying at the relay UE.

Aspect 2 is the method of aspect 1, where identifying the feasibility of the FD relaying at the relay UE further includes identifying that the FD relaying at the relay UE is feasible, and where the FD relay assistance information message includes an indication that the FD relaying at the relay UE is feasible.

Aspect 3 is the method of aspect 2, where the FD relay assistance information message further includes an indication of a relay UE-recommended number of sidelink grants associated with the FD relaying at the relay UE.

Aspect 4 is the method of any of aspects 2 and 3, where the FD relay assistance information message further includes one or more indications of one or more relay UE-recommended parameters for at least one sidelink grant associated with the FD relaying at the relay UE, and the one or more relay UE-recommended parameters for the at least one sidelink grant include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE for the remote UE.

Aspect 5 is the method of any of aspects 2 to 4, where the FD relay assistance information message further includes one or more indications of one or more relay UE-recommended parameters for a downlink transmission associated with the FD relaying at the relay UE, and the one or more relay UE-recommended parameters for the downlink transmission include at least one of a downlink time/frequency resource, a downlink transmission power, a downlink transmission timing, or one or more downlink MIMO parameters.

Aspect 6 is the method of aspect 5, where the one or more downlink MIMO parameters include at least one of a rank, a precoding matrix, a downlink beam ID, a downlink TCI state ID, or a downlink mTRP scheme.

Aspect 7 is the method of any of aspects 1 to 6, further including: identifying a feasibility of FD HARQ-ACK feedback at the relay UE, the FD HARQ-ACK feedback at the relay UE including simultaneous HARQ-ACK feedback associated with a first downlink transmission from the network node and at least one first sidelink transmission from the relay UE, where the FD relay assistance information message further includes an indication of the identified feasibility of the FD HARQ-ACK feedback.

Aspect 8 is the method of aspect 7, where the FD relay assistance information message further includes one or more indications of one or more relay UE-recommended parameters for at least one HARQ-ACK feedback associated with the FD HARQ-ACK feedback at the relay UE, and the one or more relay UE-recommended parameters for the at least one HARQ-ACK feedback include at least one of a time/frequency resource, a transmission timing, a transmission power, a beam ID, or a TCI state ID.

Aspect 9 is the method of any of aspects 1 to 8, where the FD relay assistance information message is transmitted based on one of periodic scheduling, semi-persistent scheduling, or aperiodic scheduling.

Aspect 10 is the method of any of aspects 1 to 8, further including: receiving a configuration associated with a trigger event from the network node, where the FD relay assistance information message is transmitted via a UCI message or a MAC-CE based on the trigger event occurring at the relay UE.

Aspect 11 is the method of any of aspects 1 to 8, where the FD relay assistance information message is transmitted via a HARQ-ACK feedback associated with a downlink transmission.

Aspect 12 is the method of aspect 11, where the FD relay assistance information message further includes an indication of an application time associated with the identified feasibility of the FD relaying.

Aspect 13 is the method of any of aspects 1 to 12, further including: receiving a first downlink transmission from the network node and transmitting at least one first sidelink transmission to the remote UE simultaneously based on the FD relay assistance information message.

Aspect 14 is a method of wireless communication at a network node, including receiving an FD relay assistance information message from a relay UE, the FD relay assistance information message including an indication of feasibility of FD relaying at the relay UE, the FD relaying at the relay UE including simultaneous downlink reception from the network node and sidelink transmission to a remote UE; and scheduling a first downlink transmission from the network node to the relay UE and at least one first sidelink transmission from the relay UE to the remote UE based on the FD relay assistance information message.

Aspect 15 is the method of aspect 14, where the FD relay assistance information message includes an indication that the FD relaying at the relay UE is feasible.

Aspect 16 is the method of aspect 15, where the FD relay assistance information message further includes an indication of a relay UE-recommended number of sidelink grants associated with the FD relaying at the relay UE.

Aspect 17 is the method of any of aspects 15 and 16, where the FD relay assistance information message further includes one or more indications of one or more relay UE-recommended parameters for at least one sidelink grant associated with the FD relaying at the relay UE, and the one or more relay UE-recommended parameters for the at least one sidelink grant include at least one of a sidelink time/frequency resource, a sidelink transmission timing, a transmission power, a beam ID, a TCI state ID, a rank, a precoding matrix, an mTRP scheme, a remote UE ID, or an amount of buffered data at the relay UE for the remote UE.

Aspect 18 is the method of any of aspects 15 to 17, where the FD relay assistance information message further includes one or more indications of one or more relay UE-recommended parameters for a downlink transmission associated with the FD relaying at the relay UE, and the one or more relay UE-recommended parameters for the downlink transmission include at least one of a downlink time/frequency resource, a downlink transmission power, a downlink transmission timing, or one or more downlink MIMO parameters.

Aspect 19 is the method of aspect 18, where the one or more downlink MIMO parameters include at least one of a rank, a precoding matrix, a downlink beam ID, a downlink TCI state ID, or a downlink mTRP scheme.

Aspect 20 is the method of any of aspects 14 to 19, where the FD relay assistance information message further includes an indication of feasibility of FD HARQ-ACK feedback at the relay UE, the FD HARQ-ACK feedback at the relay UE including simultaneous HARQ-ACK feedback associated with the first downlink transmission from the network node and the at least one first sidelink transmission from the relay UE.

Aspect 21 is the method of aspect 20, where the FD relay assistance information message further includes one or more indications of one or more relay UE-recommended parameters for at least one HARQ-ACK feedback associated with the FD HARQ-ACK feedback at the relay UE, and the one or more relay UE-recommended parameters for the at least one HARQ-ACK feedback include at least one of a time/frequency resource, a transmission timing, a transmission power, a beam ID, or a TCI state ID.

Aspect 22 is the method of any of aspects 14 to 21, where the FD relay assistance information message is received based on one of periodic scheduling, semi-persistent scheduling, or aperiodic scheduling.

Aspect 23 is the method of any of aspects 14 to 21, further including: transmitting, for the relay UE, a configuration associated with a trigger event, where the FD relay assistance information message is received via a UCI message or a MAC-CE based on the trigger event occurring at the relay UE.

Aspect 24 is the method of any of aspects 14 to 21, where the FD relay assistance information message is received via a HARQ-ACK feedback associated with a downlink transmission.

Aspect 25 is the method of aspect 24, where the FD relay assistance information message further includes an indication of an application time associated with the feasibility of the FD relaying.

Aspect 26 is an apparatus for wireless communication including at least one processor coupled to at least one memory and, based at least in part on information stored in the at least one memory, the at least one processor is configured to implement a method as in any of aspects 1 to 25.

Aspect 27 may be combined with aspect 26 and further includes a transceiver coupled to the at least one processor.

Aspect 28 is an apparatus for wireless communication including means for implementing any of aspects 1 to 25.

Aspect 29 is a computer-readable storage medium (e.g., a non-transitory computer-readable storage medium) storing computer executable code, where the code when executed by a processor causes the processor to implement any of aspects 1 to 25.

Various aspects have been described herein. These and other aspects are within the scope of the following claims.

What is claimed is:

1. An apparatus for wireless communication at a relay user equipment (UE), comprising:
at least one memory; and
at least one processor coupled to the at least one memory and, based at least in part on information stored in the at least one memory, the at least one processor is configured to:
identify a feasibility of full-duplex (FD) relaying at the relay UE, the FD relaying at the relay UE comprising simultaneous downlink reception from a network node and sidelink transmission to a remote UE; and
transmit, for the network node, an FD relay assistance information message based on the identified feasibility of the FD relaying at the relay UE.

2. The apparatus of claim 1, wherein to identify the feasibility of the FD relaying at the relay UE, the at least one processor is further configured to:
identify that the FD relaying at the relay UE is feasible, and wherein the FD relay assistance information message includes an indication that the FD relaying at the relay UE is feasible.

3. The apparatus of claim 2, wherein the FD relay assistance information message further includes an indication of a relay UE-recommended number of sidelink grants associated with the FD relaying at the relay UE.

4. The apparatus of claim 2, wherein the FD relay assistance information message further includes one or more indications of one or more relay UE-recommended parameters for at least one sidelink grant associated with the FD relaying at the relay UE, and the one or more relay UE-recommended parameters for the at least one sidelink grant include at least one of a sidelink time/frequency resource, a sidelink transmission timing, a transmission power, a beam identifier (ID), a transmission configuration indicator (TCI) state ID, a rank, a precoding matrix, a multi-transmission reception point (mTRP) scheme, a remote UE ID, or an amount of buffered data at the relay UE for the remote UE.

5. The apparatus of claim 2, wherein the FD relay assistance information message further includes one or more indications of one or more relay UE-recommended parameters for a downlink transmission associated with the FD relaying at the relay UE, and the one or more relay UE-recommended parameters for the downlink transmission include at least one of a downlink time/frequency resource, a downlink transmission power, a downlink transmission timing, or one or more downlink multiple-input-multiple-output (MIMO) parameters.

6. The apparatus of claim 5, wherein the one or more downlink MIMO parameters include at least one of a rank, a precoding matrix, a downlink beam identifier (ID), a downlink transmission configuration indicator (TCI) state ID, or a downlink multi-transmission reception point (mTRP) scheme.

7. The apparatus of claim 1, the at least one processor being further configured to:
identify a feasibility of FD hybrid automatic repeat request-acknowledgement (HARQ-ACK) feedback at the relay UE, the FD HARQ-ACK feedback at the relay UE comprising simultaneous HARQ-ACK feedback associated with a first downlink transmission from the network node and at least one first sidelink transmission from the relay UE,
wherein the FD relay assistance information message further includes an indication of the identified feasibility of the FD HARQ-ACK feedback.

8. The apparatus of claim 7, wherein the FD relay assistance information message further includes one or more indications of one or more relay UE-recommended parameters for at least one HARQ-ACK feedback associated with the FD HARQ-ACK feedback at the relay UE, and the one or more relay UE-recommended parameters for the at least one HARQ-ACK feedback include at least one of a time/frequency resource, a transmission timing, a transmission power, a beam identifier (ID), or a transmission configuration indicator (TCI) state ID.

9. The apparatus of claim 1, wherein to transmit the FD relay assistance information message, the at least one processor is configured to transmit the FD relay assistance information message based on one of periodic scheduling, semi-persistent scheduling, or aperiodic scheduling.

10. The apparatus of claim 1, the at least one processor being further configured to:
receive a configuration associated with a trigger event from the network node, wherein to transmit the FD relay assistance information message, the at least one processor is configured to transmit the FD relay assistance information message via an uplink control information (UCI) message or a medium access control-control element (MAC-CE) based on the trigger event occurring at the relay UE.

11. The apparatus of claim 1, wherein to transmit the FD relay assistance information message, the at least one processor is configured to transmit the FD relay assistance information message via a hybrid automatic repeat request-acknowledgement (HARQ-ACK) feedback associated with a downlink transmission.

12. The apparatus of claim 11, wherein the FD relay assistance information message further includes an indication of an application time associated with the identified feasibility of the FD relaying.

13. The apparatus of claim 1, the at least one processor being further configured to:
receive a first downlink transmission from the network node and transmit at least one first sidelink transmission to the remote UE simultaneously based on the FD relay assistance information message.

14. The apparatus of claim 1, further comprising a transceiver coupled to the at least one processor, wherein to transmit the FD relay assistance information message, the at least one processor is configured to transmit, for the network node via the transceiver, the FD relay assistance information message.

15. A method of wireless communication at a relay user equipment (UE), comprising:
identifying a feasibility of full-duplex (FD) relaying at the relay UE, the FD relaying at the relay UE comprising simultaneous downlink reception from a network node and sidelink transmission to a remote UE; and
transmitting, for the network node, an FD relay assistance information message based on the identified feasibility of the FD relaying at the relay UE.

16. The method of claim 15, wherein identifying the feasibility of the FD relaying at the relay UE further comprises:
identifying that the FD relaying at the relay UE is feasible, and wherein the FD relay assistance information message includes an indication that the FD relaying at the relay UE is feasible.

17. The method of claim 16, wherein the FD relay assistance information message further includes an indication of a relay UE-recommended number of sidelink grants associated with the FD relaying at the relay UE.

18. The method of claim 16, wherein the FD relay assistance information message further includes one or more indications of one or more relay UE-recommended parameters for at least one sidelink grant associated with the FD relaying at the relay UE, and the one or more relay UE-recommended parameters for the at least one sidelink grant include at least one of a sidelink time/frequency resource, a sidelink transmission timing, a transmission power, a beam identifier (ID), a transmission configuration indicator (TCI) state ID, a rank, a precoding matrix, a multi-transmission reception point (mTRP) scheme, a remote UE ID, or an amount of buffered data at the relay UE for the remote UE.

19. The method of claim 16, wherein the FD relay assistance information message further includes one or more indications of one or more relay UE-recommended parameters for a downlink transmission associated with the FD relaying at the relay UE, and the one or more relay UE-recommended parameters for the downlink transmission include at least one of a downlink time/frequency resource, a downlink transmission power, a downlink transmission timing, or one or more downlink multiple-input-multiple-output (MIMO) parameters.

20. The method of claim 19, wherein the one or more downlink MIMO parameters include at least one of a rank, a precoding matrix, a downlink beam identifier (ID), a downlink transmission configuration indicator (TCI) state ID, or a downlink multi-transmission reception point (mTRP) scheme.

21. The method of claim 15, further comprising:
identifying a feasibility of FD hybrid automatic repeat request-acknowledgement (HARQ-ACK) feedback at the relay UE, the FD HARQ-ACK feedback at the relay UE comprising simultaneous HARQ-ACK feedback associated with a first downlink transmission from the network node and at least one first sidelink transmission from the relay UE,
wherein the FD relay assistance information message further includes an indication of the identified feasibility of the FD HARQ-ACK feedback.

22. The method of claim 21, wherein the FD relay assistance information message further includes one or more indications of one or more relay UE-recommended parameters for at least one HARQ-ACK feedback associated with the FD HARQ-ACK feedback at the relay UE, and the one or more relay UE-recommended parameters for the at least one HARQ-ACK feedback include at least one of a time/frequency resource, a transmission timing, a transmission power, a beam identifier (ID), or a transmission configuration indicator (TCI) state ID.

23. The method of claim 15, wherein the FD relay assistance information message is transmitted based on one of periodic scheduling, semi-persistent scheduling, or aperiodic scheduling.

24. The method of claim 15, further comprising:
receiving a configuration associated with a trigger event from the network node, wherein the FD relay assistance information message is transmitted via an uplink control information (UCI) message or a medium access control-control element (MAC-CE) based on the trigger event occurring at the relay UE.

25. The method of claim 15, wherein the FD relay assistance information message is transmitted via a hybrid automatic repeat request-acknowledgement (HARQ-ACK) feedback associated with a downlink transmission.

26. The method of claim 25, wherein the FD relay assistance information message further includes an indication of an application time associated with the identified feasibility of the FD relaying.

27. The method of claim 15, further comprising:
receiving a first downlink transmission from the network node and transmitting at least one first sidelink transmission to the remote UE simultaneously based on the FD relay assistance information message.

28. An apparatus for wireless communication at a network node, comprising:
at least one memory; and
at least one processor coupled to the at least one memory and, based at least in part on information stored in the at least one memory, the at least one processor is configured to:
receive a full-duplex (FD) relay assistance information message from a relay user equipment (UE), the FD relay assistance information message including an indication of feasibility of FD relaying at the relay UE, the FD relaying at the relay UE comprising simultaneous downlink reception from the network node and sidelink transmission to a remote UE; and
schedule a first downlink transmission from the network node to the relay UE and at least one first sidelink transmission from the relay UE to the remote UE based on the FD relay assistance information message.

29. The apparatus of claim 28, wherein the FD relay assistance information message includes an indication that the FD relaying at the relay UE is feasible.

30. A method of wireless communication at a network node, comprising:
receiving a full-duplex (FD) relay assistance information message from a relay user equipment (UE), the FD relay assistance information message including an indication of feasibility of FD relaying at the relay UE, the FD relaying at the relay UE comprising simultaneous downlink reception from the network node and sidelink transmission to a remote UE; and
scheduling a first downlink transmission from the network node to the relay UE and at least one first sidelink transmission from the relay UE to the remote UE based on the FD relay assistance information message.
